(19) United States
(12) Patent Application Publication
(10) Pub. No.: US 2003/0098661 A1
(43) Pub. Date: May 29, 2003

(54) Control system for vehicle seats

(76) Inventor: Ken Stewart-Smith, Calgary (CA)

Correspondence Address: Patent Law & Venture Group, Suite K-105, 3151 Airway Ave., Costa Mesa, CA, 92626, US

(21) Appl. No.: 10/272,723

(22) Filed: Oct. 16, 2002

Related U.S. Application Data
(63) Continuation-in-part of application No. 09/997,837, filed on Nov. 29, 2001.

(51) Int. Cl. H02H 7/08; H02P 1/00

(52) U.S. Cl. 318/445

(57) ABSTRACT

A control system architecture controlling one or more vehicle seats; providing the vehicle seats with a plurality of electronic devices including actuators, sensors and controllers; integrating the actuators, sensors and controllers into the vehicle seats; and interconnecting the actuators, sensors and controllers over a common serial bus through programmable connectors. Each of the programmable connectors associated with any given device provides a unique address for that device that allows the device to be specifically addressed and perform specific functions based on the electrical signals specifically targeted for the electronic device, whereby the plurality of the electrical signals are transmitted and received over the common serial bus simultaneously without interference.

### RELATED APPLICATIONS

This is a continuation-in-part application of a prior filed and currently pending application having U.S. Ser. No. 09/997,837 and file date of Nov. 29, 2001.

### INCORPORATION BY REFERENCE

Applicant(s) hereby incorporate herein by reference, any and all U.S. patents, U.S. patent applications, and other documents and printed matter cited or referred to in this application.

### BACKGROUND OF THE INVENTION

1. Field of the Invention

The present invention relates generally to electrical and electronic system architecture and, more particularly, to system architecture for an articulated vehicle seat or for a collection of seats, as for a commercial airliner.

2. Description of Related Art

The prior art most relevant to the instant invention includes:

Hayden et al, U.S. Pat. No. 6,198,244 teaches a vehicle seat including a seat cushion and a seat back. The vehicle seat includes a plurality of electronic devices secured to both the seat cushion and the seat back. These electronic devices allow the occupant of the vehicle seat to control the features of the vehicle seat that are electronically modified, i.e., position, orientation, temperature, and the activation of lumber support and or massage devices, if any. The vehicle seat also includes a plurality of sensors associated with each of the electronic devices. Each of the sensors determines the condition of status of the electronic device to which the sensor is associated. At least one serial bus connects all of the electronic devices and sensors to a single control unit that receives all of the data from the sensor and, depending on the instructions input by the occupant of the vehicle seat, controls the electronic devices. The control unit can be integrated into the occupant position switch assembly. A smart connector is used between each of the sensors, electronic devices and the serial bus. The smart connectors retrieve the portion of the signals being transmitted over the serial bus that are to be utilized by the electronic devices. In addition, the smart connectors also allow the proper flow of data from the sensors along the serial bus to ensure the control unit receives the data.

Tual et al, U.S. Pat. No. 6,194,853 relates to an installation for operating seat modules (12) equipped with an assembly of actuators (30, 32, 34, 36, 38, 40, 42, 44) each intended for adjusting a seat element (22, 24, 26, 28). It comprises a control unit (16) suited to each seat module (12). This control unit (16) comprises means (62) for the acquisition of variables representing the functioning state of the seat module. A central unit (18) for the management of the seat modules (12) is connected to the control unit (16). It comprises means (96) for the transmission of information toward the control units (16). Each control unit (16) comprises means (66) for the transmission of variables representing the functioning state of the associated seat module toward the central management unit (18). Use in aircraft seats.

Card et al, U.S. Pat. No. 5,576,698 shows an array of like system modules linked to a common control unit by connect lines, bussed and connected to all the modules by respective removable pin units so that each module address can be generated solely according to which said pin units are not connected.

Strong, Jr., et al., U.S. Pat. No. 5,029,209 describes a pseudorandom, iterative method and apparatus for automatically creating an address for each remote unit of a data communication network comprising a plurality of remote units, such as the seat electronic units of a passenger airliner, and a central unit, such as a central transmitter/receiver unit. The formats of the message frames that control the flow of data between the central unit and the plurality of remote units includes a synchronization word, a command word, and a series of data word segments. The number of data word segments is equal to or greater than the number of remote units. The pseudorandom, iterative method and apparatus assigns addresses such that one and only one remote unit is associated with a data word segment position. First, the central unit transmits an address assign phase 1 command to each remote unit. In response, each remote unit randomly selects a data word segment position and replies to the central unit in the selected position. Next, the central unit transmits an address assign phase 2 command. All of the remote units that replied in the first data word segment position that contained a reply respond to the address assign phase 2 command. All other remote units are locked out. The responding remote units randomly select another data word segment position and respond to the central unit in the selected position. The central unit retransmits an address assign phase 2 command. All of the remote units that responded, in the first data word segment position that contained a response, reply to the address assign phase 2 retransmission. All of the remote units that responded in other positions are locked out. The transmission of address assign phase 2 commands is repeated for N cycles. Alternatively, the process can be repeated until the remote unit response is found to be error-free, which indicates that the response was produced by a single remote unit. In either case, after completion of the address assign phase 2 command transmissions, the central unit transmits an address assign phase 3 command, which instructs the single responding remote unit to assign itself a unique address and, then, lock itself out of the iterative process. Thereafter, the entire process is repeated until no further responses are received to an address assign phase 1 command.

Wax et al., U.S. Pat. No. 5,745,159 describes a distribution system for a passenger entertainment system that provides appropriate in-line amplification and equalization of an entertainment signal carried on a common bus. The distribution system is comprised of a network of zone management units (ZMUs) and seat electronics units (SEUs) connected to the bus. Each ZMU contains a variable gain amplifier in series with the bus to amplify the entertainment signal carried on the bus. Each ZMU also contains a variable slope compensation network that is continuously adjusted to equalize the amplitude of the entertainment signal across the signal bandwidth. Each SEU contains a variable gain amplifier in series with the bus to amplify the entertainment signal carried on the bus. Each SEU also contains a fixed slope compensation network that may be switched in series with the bus to equalize the amplitude of the entertainment signal across the signal bandwidth. Initialization routines are disclosed to initially configure the ZMUs and SEUs in the distribution system prior to system operation.

Booth et al., U.S. Pat. No. 5,835,127 describes an integrated electronic system that provides telephone, interactive entertainment and other amenities on a vehicle of transportation. The integrated electronic system includes a passenger control unit coupled through a multiple seat electronic unit via a universal interface. The integrated electronic system further includes a passenger control handset directly coupled to the passenger control unit to provide telephony and display control information to the passenger control unit. The passenger control unit appropriately routes the information to the multiple seat electronics unit through the universal interface.

Atkinson, U.S. Pat. No. 5,854,591 describes a digital in-transit entertainment system that assists in providing passenger services to a plurality of end nodes of a vehicle. The system includes a multi-drop digital communication bus, preferably configured to support RS-485 standards. A plurality of zone bridge units (“ZBUs”) and a system manager unit (“SMU”) are coupled to the digital communication bus. At least one ZBU is responsible for signaling headend equipment to perform a requested passenger service. The SMU is also designed to signal another type of equipment if implemented in lieu of the first type. Both the ZBUs as well as the SMU are designed to contain PSS status information for every end node of the vehicle to maintain coherency.

Troxel et al., U.S. Pat. No. 6,014,381 describes a passenger entertainment system of an aircraft utilized to distribute audio and/or video in a digital format throughout a vehicle. The passenger entertainment system includes an Asynchronous Transfer Mode (“ATM”) network interconnected to a high speed, serial distribution network propagating information in a predetermined format. Collectively, these digital networks support the broadcast of audio and/or video in real-time as well as actual “video on demand” services The prior art teaches the use of a control architecture for controlling a vehicle seat but does not teach the novel architecture defined and taught in the present invention which is summarized below.

Marshland, U.S. Pat. No. 6,047,124 describes a system and method for tracing device drivers using a computer is described. A memory is interconnected with a processor in the computer and configured into a user memory space and a kernel memory space. An application process executes on the processor within the user memory space. An operating system kernel executes on the processor within the kernel memory space with a traced device driver. A tracing device driver executes on the processor within the kernel memory space and is interposed between the application process and the traced device driver to trace interactions occurring between the traced device driver and the application process and the kernel operating system. A tracing process executes on the processor within the user memory space and interfaces with the tracing device driver. The tracing process controls the tracing device driver in accordance with user-specified parameters and includes a display for result sets generated by the tracing device driver.

Reed et al., U.S. Pat. No. 6,058,288 describes an entertainment and passenger service system for use in aircrafts and other passenger vehicles. Video monitors are provided at the passenger seats which are connected to entertainment sources located at a head end location via a direct, individual, point to point signal over a star network. An electronic switching unit is provided to connect the entertainment sources to the video monitors. A communications control unit provides communication connections between the passenger seat and the entertainment sources.

Park et al., U.S. Pat. No. 6,170,786 describes a seat for, for example, an aircraft that has an open outer shell which embraces a seat portion, a seat back, a head rest and a foot rest when the seat is in an upright position. Also embraced by the shell are a pair of arm rests. The seat is reclinable into a bed configuration such that the seat portion is moved forwardly out of the open end of the shell. Simultaneously, the arm rests are movable between the raised position and the position substantially flush with the seat portion. In the bed configuration, the removal of the arm rests from the raised position significantly increases the width of the bed, thus enhancing the comfort of the user.

Clearly, the prior art teaches that a serial bus may be used to carry data signals for the actuation of servo control mechanisms in passenger seats. However, the prior art does not teach such a bus and distributed device system whereby each connector on the bus contains the address for the associated device rather than the address being a part of the device. In this manner, a specific device may be replaced without undue reprogramming of the control system or of termination -codes. The present invention provides such control and further related advantages.

### SUMMARY OF THE INVENTION

The present invention teaches certain benefits in construction and use which give rise to the objectives described below.

The present invention is a vehicle seat control system such as may be found in commercial aircraft as well as land vehicles. The same system architecture may be used to control a single seat as well as a bank of seats as in a commercial aircraft. The basic apparatus scheme and control method is fully scalable. Generally, the system comprises a plurality of electrically operated devices including actuators, sensors, controllers, motors and various servomechanisms, which are integrated into the vehicle seat or seats as well as the surrounding environment. Interconnection of all of these discrete components is via a common serial bus through programmable connectors containing the address of each device. Electrical signals move between devices, sensors and controllers on the bus. Each of the programmable connectors joins the bus with one of the devices and allows the device to determine which signals correspond to the device, while rejecting the signals that correspond to other devices. The bus acts as an interconnecting transmission line and is impressed with digital packets of information, which are addressed for each device. The transmission line is able to carry a large number of the information packets in series at one time for apparent simultaneous communication between all of the devices at once. The protocol can be TCP/IP as is used widely on the Internet, or any other packetized digital transmission protocol. The important issue in this invention is that as few as two wires can be used to interconnect a complex communication system for direct communication between many devices and sensors with one or more controllers. The invention system allows simultaneous movement. All actuators may be turned on at the same time and fully variable actuator speed may be set independently of all other actuators. In the prior art multiwire design, shared motor driver resources do not always allow for full simultaneous movement or independent variable speed. In the present design the device address is built into the connector so no reconfiguration of devices is required when the devices are replaced. Advantages include greatly reduced wiring, reduced electromagnetic interference, reduced weight and volume and ease of expansion to accommodate the large variety of seat programs. This is significant when a single controller is controlling banks of two or more seats. When repairs must be completed in a short time, usually during turnaround simple replacement of devices without reconfiguration of addresses is vital. The cable-addressing scheme greatly simplifies the exchange of faulty units. There are currently many addressing schemes including internal dip switches, jumpers or even programmable addressing where the device address is programmed into the device's EEPROM. Schemes where a magnet is temporarily attached to a module to identify it as the module to be programmed are known. All of the above addressing schemes involve the address being a part of the device. A typical aircraft passenger seat has as many as five actuators. Identical electrical devices-will control each of these actuators. The address for each device-may be implemented by any of the above schemes but the invention teaches that a better way to address the devices-is to make the address a part of the wiring harness or cable. In this way, the device-address is unique to the physical location on the cable and changing out the device does not require any address programming or jumper changes.

A primary objective of the present invention is to provide a seating system having advantages not taught by the prior art.

Another objective is to provide such a system capable of using a two-wire bus for transmitting information between sensors, actuators, devices and controllers.

A further objective is to provide such a system capable of replacement of any of the devices without reconfiguration of the addresses stored in the device (Plug and Play).

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is typical wiring diagram of a vehicle seating apparatus as found in the prior art;

FIG. 2 is a block diagram of a connector according to the present invention;

FIG. 3 is a perspective view of the present invention in a single seat application; and

FIG. 4 is a perspective view thereof in a multi-seat configuration.

### DETAILED DESCRIPTION OF THE INVENTION

The above described drawing figures illustrate the invention in at least one of its preferred embodiments, which is further defined in detail in the following description.

The present invention is a vehicle seat control system apparatus comprising a plurality of electrical devices including actuators, sensors and controllers, integrated into a vehicle seat and interconnected over a common serial bus through programmable connectors. The serial bus includes both power and data signals. A preferred embodiment of the programmable connector of the present invention is illustrated in FIG. 2. Each electrical device 5 contains a device connector 6 that connects the device to the serial bus 11 through a programmable connector 10. Programmable connectors 10 are the interconnecting elements between the bus and the devices.

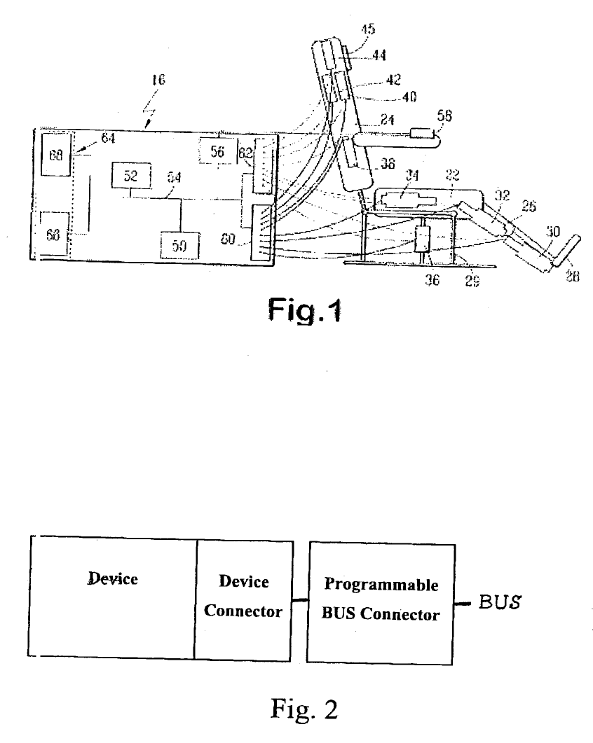

In this arrangement all of the devices are arrange in parallel with each other and joined with a common bus structure as shown. The bus shows 4 conductor paths. Two are for control and sensor signals and two are for power signals. Is should be noticed that, in this arrangement, all of the devices are arranged in a parallel system in contrast to the prior art, which, as shown in FIG. 1 are all interconnected with the controller directly, requiring a massive wiring structure. In this system plural electrical signals are transmitted and received over the common serial bus simultaneously without interference, i.e., the information is sent in packets and the bus handles a large number of these information packets at the same time all moving in sequence to their designations. The bus is also able to handle power signals for providing actuation power and data signals superimposed on the power signals as is well known in the electrical power systems transmission line technology.

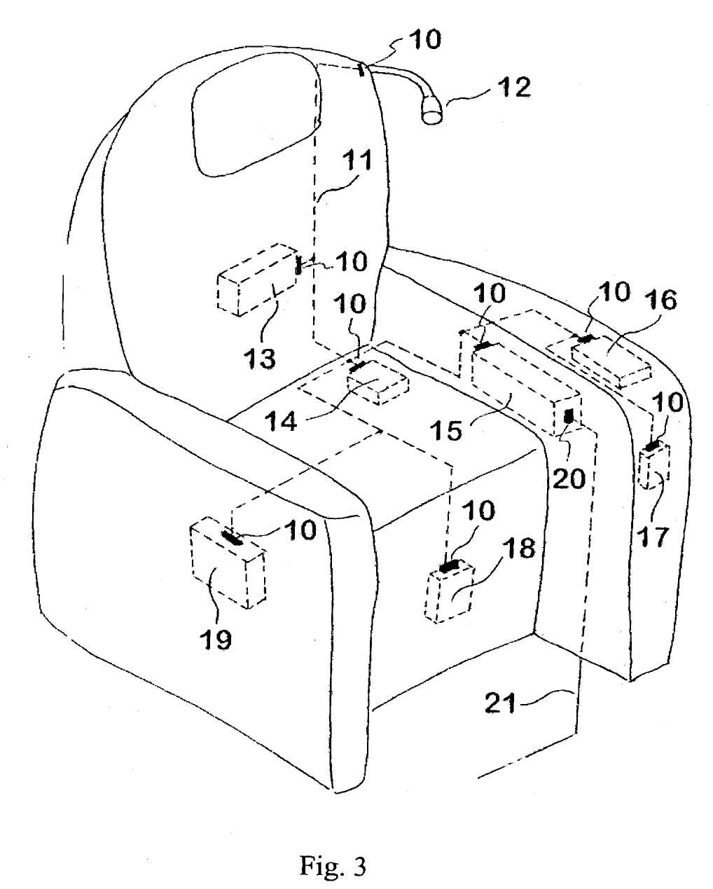

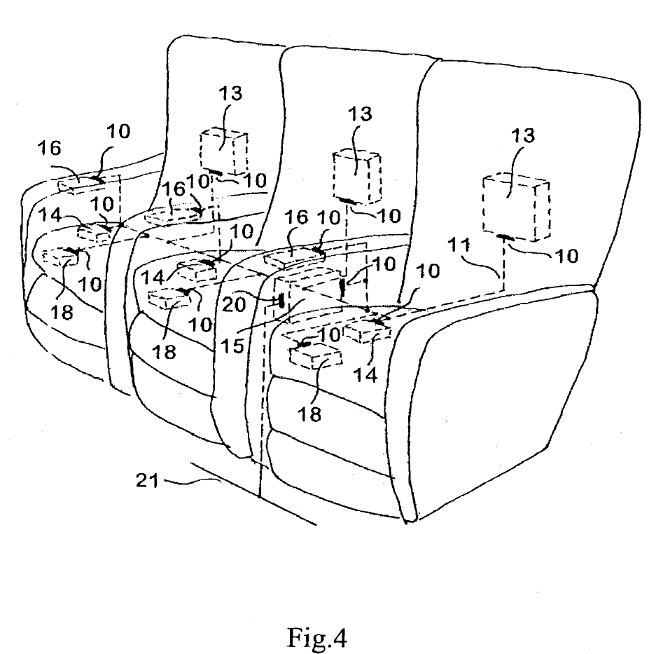

The electronic devices are preferably distributed on the serial bus, that is, they are placed at various locations such as in and about an aircraft seat structure. Such an arrangement is shown in FIG. 3 where the power supply feeds power to a controller 15 which is interconnected to a number of individual devices such as via a CAN bus for one example. Such devices include electric motors and mechanical actuation devices of any kind. Preferably, at least on motor is positioned proximate to one of the controllers so that the power transmission distance is as short as possible. Also, preferably, the sensors are positioned adjacent to the actuators to which they relate so as to form an integrated relationship for improved signal transmission efficiency.

In a further embodiment, the present invention is a vehicle seat control system apparatus comprising a plurality of vehicle seats, each having one or a plurality of electronic devices including actuators, sensors and controllers, integrated into the vehicle seats and interconnected over a common serial bus through programmable connectors. Each of the programmable connectors allows the device to act on only electrical signals targeted for the specific electronic device, whereby plural of the electrical signals are transmitted and received over the common serial bus simultaneously without interference. This results in the ability to operate the plurality of seats at the same time, or apparently at the same time.

The devices are interconnected to each other as shown if FIG. 3 over a common serial power data bus 11 using programmable connectors 10. The devices, sensors and motors are positioned for highest efficiency in data transmission. These devices include a reading light module 12, lumbar module 13, recline actuator driver and sensor module 14, the seat controller module 15, the keypad module 16, PED power port 17, legrest actuator driver and sensor module 18 and an audio/video module 19. The controller module 15 contains a second programmable connector 20 that allows the seat to be connected over a second serial power data bus 21 to other seats, seat assemblies or seat monitoring stations (not shown).

As before described, the electrical signals include power signals and data signals and the electronic devices are distributed over the serial bus, i.e., in different locations in each of, and between the seats. Again, the devices, sensors and motors are positioned for highest efficiency in data transmission.

The present method of use of the invention provides for operation through the provisioning of plural vehicle seats; providing the vehicle seats with a plurality of electronic devices including actuators, sensors and controllers; integrating the actuators, sensors and controllers into the vehicle seats; and interconnecting the actuators, sensors and controllers over a common serial bus through programmable connectors. Each of the programmable connectors associated with any given device provides a unique address for that device that allows the device to be specifically addressed and perform specific functions based on the electrical signals specifically targeted for an integral one of the electronic devices, whereby the plurality of the electrical signals are transmitted and received over the common serial bus simultaneously without interference.

The method provides for using electrical signals which may include power signals and data signals as well as any other type of signal that may be of advantage.

The method further provides for the distributing of the electronic devices on the serial bus, and such distribution preferably includes the step of positioning motors proximate the controllers and sensors adjacent to the actuators.

In summary, it has been shown that a vehicle seating control system apparatus may comprise a plurality of electronic devices including actuators, sensors and controllers, integrated into at least one vehicle seat and interconnected over a common serial bus through programmable connectors, where such programming may be easily accomplished by using jumpers or equivalent means, as is known in the art. The serial bus transmits a plurality of signals, where only some of these signals are to be recognized by a given servo-control device. Each one of the programmable connectors is thus adapted for enabling the electronic devices interconnected to it to respond exclusively to the subset of the plurality of signals specifically addressed thereto.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A vehicle seating control system apparatus comprising: a plurality of electronic devices including actuators, sensors and controllers, integrated into at least one vehicle seat and interconnected over a common serial bus through programmable connectors; the serial bus transmitting a plurality of signals; wherein each one of the programmable connectors is adapted for enabling the electronic devices interconnected therewith to respond exclusively to a subset of the plurality of signals addressed thereto.

2. The apparatus of claim 1 wherein the electrical signals include power signals and data signals.

3. The apparatus of claim 1 wherein the electronic devices are distributed on the serial bus.

4. The apparatus of claim 1 wherein the electronic devices include at least one motor.

5. The apparatus of claim 4 wherein the at least one motor is positioned proximate to one of the controllers.

6. The apparatus of claim 1 wherein the sensors are adjacent to the actuators.

7. A vehicle seat control system apparatus comprising: a plurality of vehicle seats; the vehicle seats providing a plurality of electronic devices including actuators, sensors and controllers, integrated into the vehicle seats and interconnected over a common serial bus through programmable connectors; the serial bus transmitting a plurality of signals; wherein each one of the programmable connectors is adapted for enabling the electronic devices interconnected therewith to respond exclusively to a subset of the plurality of signals addressed thereto.

8. The apparatus of claim 7 wherein the electrical signals include power signals and data signals.

9. The apparatus of claim 7 wherein the electronic devices are distributed on the serial bus.

10. The apparatus of claim 7 wherein the electronic devices include at least one motor.

11. The apparatus of claim 10 wherein the at least on motor is positioned proximate to one of the controllers.

12. The apparatus of claim 1 wherein the sensors are adjacent to the actuators.

13. A vehicle seat control method comprising the steps of: providing a plurality of vehicle seats; providing the vehicle seats with a plurality of electronic devices including actuators, sensors and controllers; integrating the actuators, sensors and controllers into the vehicle seats; interconnecting the actuators, sensors and controllers over a common serial bus through programmable connectors; the serial bus transmitting a plurality of signals; wherein each one of the programmable connectors is adapted for enabling the electronic devices interconnected therewith to respond exclusively to a subset of the plurality of signals addressed thereto.

14. The method of claim 13 further comprising the step of distributing the electronic devices on the serial bus.

15. The method of claim 13 further comprising the step of positioning the at least one motor proximate to one of the controllers.

16. The method of claim 13 further comprising the step of positioning the sensors adjacent to the actuators.
